(19) United States
(12) Patent Application Publication
(10) Pub. No.: US 2025/0056070 A1
(43) Pub. Date: Feb. 13, 2025

(54) VIDEO IMPLANTATION METHOD, APPARATUS, DEVICE AND COMPUTER-READABLE STORAGE MEDIUM

(71) Applicant: XINGHESHIXIAO (BEIJING) TECHNOLOGY CO., LTD., Beijing (CN)

(72) Inventors: Zuyuan LIU, Beijing (CN); Baiyun YANG, Beijing (CN)

(21) Appl. No.: 18/702,105

(22) PCT Filed: Sep. 22, 2022
(86) PCT No.: PCT/CN2022/120679

§ 371 Date: Apr. 17, 2024

(30) Foreign Application Priority Data
Oct. 21, 2021 (CN) 202111227816.4

(51) Int. Cl. H04N 21/234; G06V 10/25; H04N 21/431; H04N 21/84

(52) U.S. Cl. CPC H04N 21/23424; G06V 10/25; H04N 21/4316; H04N 21/84

(57) ABSTRACT

Embodiments of the present disclosure provide a video implantation method, a video implantation apparatus, a device and a storage medium. The method comprises steps of: analyzing a source video and recognizing one or more frames in which a visual object can be implanted; acquiring a source video clip corresponding to the one or more frames; and, implanting the visual object into the source video clip corresponding to the one or more frames, and generating one or more output videos and video description information thereof; or generating object description information according to the visual object and the source video clip corresponding to the one or more frames. In this way, when a video is analyzed and implanted, the whole source video does not need to be acquired for analysis, so that the video implantation efficiency can be improved, and the load of a processing terminal can be reduced.

### TECHNICAL FIELD

The present disclosure relates to the technical field of video processing, and in particular to the technical field of video implantation.

### BACKGROUND

At present, when other objects are implanted in a video, the processing terminal needs to acquire the whole source video and then analyze the whole source video to determine the appropriate implantation position so as to complete the implantation of the object, and the final video containing the implantation object is sent to the publisher of the source video, so that the whole process of implanting the object into the video and obtaining the final video is completed. In this object implantation mode, since the processing terminal needs to acquire the whole source video for analysis, the video implantation efficiency is low, and the processing load of the processing terminal is high.

### SUMMARY

The present disclosure provides a video implantation method, a video implantation apparatus, a device and a storage medium.

In accordance with the first aspect of the present disclosure, a video implantation method is provided. The method includes steps of:
analyzing a source video, and recognizing one or more frames in which a visual object can be implanted;
acquiring a source video clip corresponding to the one or more frames; and
implanting the visual object into the source video clip corresponding to the one or more frames, and generating one or more output videos and video description information thereof; or
generating object description information according to the visual object and the source video clip corresponding to the one or more frames.

According to the above aspect and any possible implementation, the one or more output videos and the video description information thereof are sent to the publisher, so that the publisher obtains the final video according to the video description information, the one or more output videos and the source video data of the source video clip; or
the visual object and the object description information are sent to the publisher, so that the publisher overlays the visual object on the frame corresponding to the one or more frames in the source video data in a mask manner according to the object description information; or
the masked visual object and the object description information are sent to the publisher, so that the publisher implants the masked visual object into the frame corresponding to one or more frames in a rendering fusion manner according to the object description information to obtain the final video.

According to the above aspect and any possible implementation, an implementation is further provided,
the generating object description information according to the visual object and the source video clip corresponding to the one or more frames includes:
analyzing a region of interest suitable for implantation of the visual object in the source video clip corresponding to the one or more frames to determine the object description information.

According to the above aspect and any possible implementation, an implementation is further provided,
the publisher stores multiple versions of source videos, each version of source video being different in code rate and/or language version; and
the analyzing a source video and recognizing one or more frames in which a visual object can be implanted includes:
analyzing any version of source video among the multiple versions of source videos and recognizing one or more frames in which the visual object can be implanted.

According to the above aspect and any possible implementation, an implementation is further provided, wherein the method further includes:
generating the video description information according to the respective time interval and/or frame interval of the one or more output videos, the video description information being used to describe the respective starting time and ending time of the one or more output videos in the source video data, and/or the video description information being used to describe the respective starting frame number and ending frame number of the one or more output videos in the source video data.

According to the above aspect and any possible implementation, an implementation is further provided, wherein the analyzing the one or more videos to determine one or more frames in which the visual object can be implanted includes:
performing semantic analysis and/or content analysis on the source video through a video port provided by a publisher, or performing semantic analysis and/or content analysis on a low code rate source video, to determine one or more videos in the source video that satisfy a preset requirement; and
analyzing the one or more videos to determine one or more frames in which the visual object can be implanted.

According to the above aspect and any possible implementation, an implementation is further provided, wherein the analyzing the one or more videos to determine one or more frames in which the visual object can be implanted includes:
analyzing the one or more videos to determine a region of interest suitable for implantation of the visual object; and
determining the frame where the region of interest is located as the one or more frames.

According to the above aspect and any possible implementation, an implementation is further provided, wherein the acquiring a source video clip corresponding to the one or more frames includes:
acquiring the frame corresponding to the one or more frames in high code rate source video data; and
the implanting the visual object into the source video clip corresponding to the one or more frames and generating one or more output videos includes:
implanting the visual object into the frame corresponding to the one or more frames in the high code rate source video data, and generating one or more output videos.

According to the above aspect and any possible implementation, an implementation is further provided, wherein the acquiring the frame corresponding to the one or more frames in high code rate source video data further includes:
acquiring the frame corresponding to the one or more frames in the high code rate source video data according to a preset security frame strategy;
wherein the preset security frame strategy is used to indicate the respective number of supplementary frames of the one or more frames.

According to the above aspect and any possible implementation, an implementation is further provided, wherein the obtaining, by the publisher, the final video according to the video description information, the one or more output videos and the source video data of the source video clip includes at least one of the following steps:
replacing, by the publisher and according to the video description information, corresponding video segments in the source video data with the one or more output videos to obtain the final video;
embedding, by the publisher and according to the video description information, the one or more output videos into the corresponding position in the source video data to obtain the final video; and
overlaying, by the publisher and according to the video description information, corresponding video segments in the source video data by using the one or more output videos to obtain the final video.

According to the above aspect and any possible implementation, an implementation is further provided, wherein the overlaying, by the publisher and according to the video description information, corresponding video segments in the source video data by using the one or more output videos to obtain the final video includes:
overlaying, by the publisher and according to the video description information, the one or more output videos on corresponding video segments in the source video data in a floating layer manner to obtain the final video; or
overlaying, by the publisher and according to the video description information, the one or more rendered and masked output videos with alpha channel information on corresponding video segments in the source video data in a floating layer manner to obtain the final video;
or
implanting, by the publisher and according to the video description information, the one or more rendered and masked output videos with alpha channel information into corresponding video segments in the source video data in a rendering fusion manner according to the alpha channel information to obtain the final video.

In accordance with the second aspect of the present disclosure, a video implantation apparatus is provided. The apparatus includes:
a first processing module configured to analyze a source video and recognize one or more frames in which a visual object can be implanted;
an acquisition module configured to acquire a source video clip corresponding to the one or more frames; and
a second processing module configured to implant the visual object into the source video clip corresponding to the one or more frames, and generate one or more output videos and video description information thereof; or
a generation module configured to generate object description information according to the visual object and the source video clip corresponding to the one or more frames.

In accordance with the third aspect of the present disclosure, an electronic device is provided. The electronic device includes: a memory and a processor, wherein the memory has computer programs stored therein, and the processor implements the method described above when executing the programs.

In accordance with the fourth aspect of the present disclosure, a computer-readable storage medium is provided, the computer-readable storage medium having computer programs stored thereon that, when executed by a processor, implement the method according to the first aspect and/or the second aspect of the present disclosure.

It should be understood that the content described in the SUMMARY is not intended to limit the crucial or important features of the embodiments of the present disclosure, as well as the scope of the present disclosure. Other features of the present disclosure will become understandable from the following description.

### BRIEF DESCRIPTION OF THE DRAWINGS

The above and other features, advantages and aspects of the embodiments of the present disclosure will become apparent with reference to the accompanying drawings and the following detailed description. The accompanying drawings are used for better understanding the scheme, and do not constitute any limitations to the present disclosure. Throughout the accompanying drawings, the same or similar reference numerals indicate the same or similar elements, in which:

FIG. 1 shows a flowchart of a video implantation method according to an embodiment of the present disclosure;

FIG. 2 shows a block diagram of a video implantation apparatus according to an embodiment of the present disclosure; and

FIG. 3 shows a block diagram of an exemplary electronic device capable of implementing the embodiments of the present disclosure.

### DETAILED DESCRIPTION

To make the objectives, technical solutions and advantages of the embodiments of the present disclosure clearer, the technical solutions in the embodiments of the present disclosure will be described clearly and completely with reference to the accompanying drawings in the embodiments of the present disclosure. Apparently, the described embodiments are some but not all of the embodiments of the present disclosure. All other embodiments obtained by a person of ordinary skill in the art without paying any creative effort on the basis of the embodiments in the present disclosure shall fall into the protection scope of the present disclosure.

In addition, as used herein, the term “and/or” is merely an association relation describing associated objects, and means that there may be three relations. For example, A and/or B may refer to the following three situations: there exists A alone; there exist both A and B; and, there exists B alone. In addition, as used herein, the character “/” generally indicates that there is an “OR” relationship between associated objects.

In the present disclosure, when a video is implanted, the whole source video does not need to be acquired for analysis, so that the analysis efficiency of the visual object can be improved, and the video implantation efficiency can thus be improved.

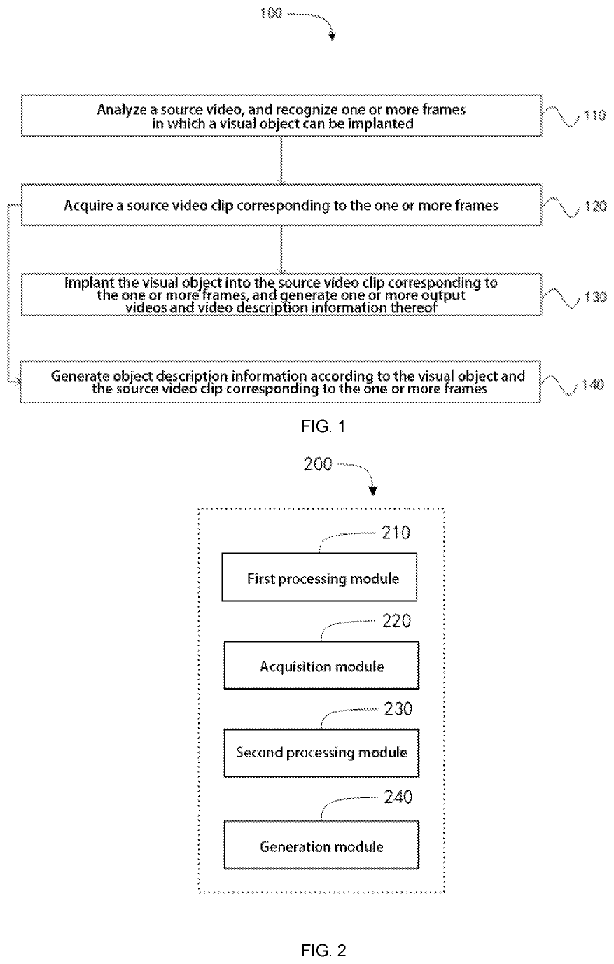

FIG. 1 shows a flowchart of a video implantation method 100 according to an embodiment of the present disclosure. As shown in FIG. 1, the method 100 is executed by a processing terminal that provides a visual object. The method 100 includes the following steps.

In step 110, a source video is analyzed, and one or more frames in which a visual object can be implanted are recognized. The visual object may be any object to be implanted, for example, mineral water, bags, stationery, new films or the like that need to be advertised. The visual object may be an animation, picture or video, or may be an animation, picture or video composed of graphs, characters, shapes, forms or other contents. The visual object may be 2D or 3D.

The complete source video does not need to be acquired during the analysis of the source video.

In step 120, a source video clip corresponding to the one or more frames is acquired.

The source video clip may be a single shot clip.

In step 130, the visual object is implanted into the source video clip corresponding to the one or more frames to generate one or more output videos and video description information thereof; or

In step S140, object description information is generated according to the visual object and the source video clip corresponding to the one or more frames. By analyzing the source video, one or more frames suitable for implantation of the visual object can be recognized. Then, the video description information or object description information can be generated by only acquiring the source video clip corresponding to the one or more frames, so that the video publisher can complete the implantation of the visual object based on the video description information or object description. By using this scheme in which the whole source video does not need to be analyzed and implanted during the implantation of the visual object and the processing terminal does not need to generate the final video, the analysis efficiency of the visual object can be obviously improved, the video implantation efficiency can be improved, and the processing load of the processing terminal can be reduced. Moreover, since it is unnecessary to acquire the whole source video, the video transmission time can be reduced, and it is advantageous to further improve the video implantation efficiency.

Secondly, during the generation of the object description information corresponding to the visual object, after the source video is analyzed and the one or more frames are recognized, the object description information can be automatically generated according to the position of the visual object in the one or more frames and the identifiers of the one or more frames, so that the publisher can automatically implant the visual object into the source video data according to the object description information to obtain the final video. In this video implantation mode, since the processing terminal does not need to the above output video, the steps in the video implantation mode are more concise, and the video implantation efficiency is higher.

The output videos may be output in the form of compressed videos or uncompressed high-definition sequence frames, and it will not be limited in the present disclosure.

Secondly, the relationship among the source video, the source video clip and the source video data will be described below:

The source video may be any slightly compressed/proportionally compressed video in which the visual object is to be implanted, or the source video may be any uncompressed high-definition video sequence frame in which the visual object is to be implanted.

The source video data is high code rate video data of the source video that is stored in the publisher, and the publisher can store video data with multiple bit rates, generally video data with the highest code rate.

The source video clip is a video clip clipped from the source video data, and is one or more video clips in the source video data. In some embodiments, video clips of the video data with different code rates can be selected for visual object implantation according to the requirements.

Finally, the way of providing the source video clip may be:
online transmission by the publisher, copying, software development kit (sdk), application programming interface (api), or providing the download address to the processing terminal through oss (cloud storage). It will not be limited in the present disclosure.

In one embodiment, the one or more output videos and the video description information thereof are sent to the publisher, so that the publisher obtains the final video according to the video description information, the one or more output videos and the source video data of the source video clip;
or
in one embodiment, the visual object and the object description information are sent to the publisher, so that the publisher overlays the visual object on the frame corresponding to the one or more frames in the source video data in a mask manner according to the object description information;
or
in one embodiment, the masked visual object and the object description information are sent to the publisher, so that the publisher implants the masked visual object into the frame corresponding to one or more frames in a rendering fusion manner according to the object description information to obtain the final video.

The way of sending the one or more output videos and video description information thereof, or the visual object and the object description information, or the masked visual object and the object description information to the publisher may be:
online/offline transmission, copying, sdk, api, or providing the download address to the publisher through oss (cloud storage). It will not be limited in the present disclosure.

The final video is generated by the publisher instead of the processing terminal, so that the load of the processing terminal can be reduced and the video transmission efficiency between the processing terminal and the publisher can be improved.

Secondly, the processing terminal sends the visual object and the object description information to the video publisher, or sends the masked visual object and the object description information to the video publisher. Compared with the situation where the processing terminal sends the output video to the video publisher, since the processing terminal does not need to send the video, the video implantation step is simplified, the transmission of data is reduced, the time of data transmission is shortened, and it is advantageous to further improve the implantation efficiency of the visual object.

In addition, it should be emphasized that, if the way of “sending the visual object and the object description information to the publisher” is adopted, it is also necessary to send the mask of the visual object to the publisher; and, if the way of “sending the masked visual object and the object description information to the publisher” is adopted, it is only necessary to send the alpha channel information of the masked visual object to the publisher by the way.

Since the mask is a black-and-white binary image and the number of masks is determined by the number of one or more frames suitable for implantation of the visual object, compared with the way of “sending the visual object and the object description information to the publisher”, in the way of “sending the masked visual object and the object description information to the publisher”, since the mask does not need to be sent separately and it is only necessary to send the alpha channel information of the masked visual object to the publisher, the data amount is small, and it is more convenient. Accordingly, the data transmission is fast, it is advantageous to improve the video implantation efficiency, and it is greatly convenient for the publisher.

The mask is a black-and-white binary image. If it is assumed that the mask is represented by a floating-point value, that is, the pixels values are represented by 0 and 1, the principle is as follows.

If the position in the mask where the pixel value is 1 is used as the display part of the masked implantation object, the position where the pixel value is 0 is an alpha transparent part (that is, alpha is 0), which is used to display the original image corresponding to this part in the source video data; conversely, if the position where the pixel value is 0 is the display part of the masked implantation object, the position where the pixel value is 1 is an alpha transparent part (that is, alpha is 0), which is used to display the original image corresponding to this part in the source video data. The alpha has a transparent gradient from 0 to 1.

Finally, the object description information is used to describe the implantation position of the visual object in the one or more frames and the specific information of the one or more frames (e.g., the serial number or other identifiers of the frame).

The implantation position of the visual object in the one or more frames may be determined according to the region of interest suitable for implantation of the visual object in the one or more frames, and
the implantation position of the visual object in the one or more frames may be an absolute position, the absolute position varies with the resolution of the video frame in the source video data, and the implantation position of the visual object is different if the resolution is different;
or
the position of the visual object in the one or more frames may also be a relative position, i.e., the position ratio of the visual object in the one or more frames;
for example, the XX key point of the visual position corresponds to the position of 30% horizontal pixels to the right on the top left corner and 20% vertical pixels to the lower on the top left corner of a frame in the one or more frames.

The publisher overlays the visual object on the frame corresponding to the one or more frames in the source video data according to the object description information.

The masked visual object is added, as an image layer, above the region of interest of the frame corresponding to the one or more frames in the source video data. The transparency of the visual object in this image layer is 1, and the transparency of other places except for the visual object is 0, so that the effect of overlaying the visual object only above the region of interest in the corresponding frame is achieved. Of course, the publisher may also implant the masked visual object into the region of interest in the corresponding frame in a rendering fusion manner according to the object description information.

The publisher can flexibly select these video implantation modes according to the requirements, so as to obtain the final video in a proper way.

Finally, in the present disclosure, after the publisher obtains the final video, the size of the video stream pushed to the user side can be flexibly selected according to the actual needs.

In one embodiment, the generating object description information according to the visual object and the source video clip corresponding to the one or more frames includes:
analyzing a region of interest suitable for implantation of the visual object in the source video clip corresponding to the one or more frames to determine the object description information.

In order to further improve the accuracy of the object description information, after the source video clip with a high code rate is obtained, the region of interest can be further analyzed, for example, being analyzed in position or size. Of course, during analysis, the pixel positions in the region of interest where the visual object should be implanted, as well as the size and scaling ratio of the visual object, can be further determined in combination with the size of the visual object, so that the implantation position of the visual object and the specific information of the implantation frame are more accurate.

Of course, theoretically, the region of interest should be larger than or equal to the implantation object. For example, a table is displayed on one side of the region of interest, the implantation object is a bottle of mineral water, and the bottle of mineral water is used for being placed on the table, so the remaining region of the region of interest should be large enough for placement of this bottle of maternal water. Specifically, the position, size or the like of the implantation object (i.e., the bottle of mineral water) can be determined according to the size of the table, the size of other objects such as drinks on the table or the like.

The specific implantation region where the visual object is finally located may also be called a visual object implantation region, which is a part of the region of interest.

In addition, it is to be noted that, if the requirement for the accuracy of the object description information is low, the processing terminal may also not obtain the source video clip. This is flexibly handled by the processing terminal according to the requirements.

In one embodiment, the publisher stores multiple versions of source videos, wherein each version of source video is different in code rate and/or language version. Different language versions mainly differ in language type, such as Chinese version and English version, and the English version is classified into American English, British English, etc.

The analyzing a source video and recognizing one or more frames in which a visual object can be implanted includes:
analyzing any version of source video among the multiple versions of source videos and recognizing one or more frames in which the visual object can be implanted.

The publisher can store multiple versions of source videos, and the processing terminal can automatically analyze any version of source video during analysis, so that the flexibility of source video analysis is improved.

In one embodiment, the method further includes:
generating the video description information according to the respective time interval and/or frame interval of the one or more output videos, the video description information being used to describe the respective starting time and ending time of the one or more output videos in the source video data, and/or the video description information being used to describe the respective starting frame number and ending frame number of the one or more output videos in the source video data.

In order to determine the time interval and/or frame interval quickly, the timestamp and frame number of the one or more frames in the source video data obtained after analyzing the source data need to be recorded, or the timestamp and frame number corresponding to the one or more frames in the high code rate source video data need to be recorded.

The video description information of the one or more output videos can be automatically generated according to the respective time interval and/or frame interval of the one or more output videos, so that the publisher can determine the starting position and ending position of the output video automatically and accurately, and it is convenient for the publisher to obtain the final video by using the video description information, the output video and the high code rate source video data.

In one embodiment, the analyzing a source video and recognizing one or more frames in which a visual object can be implanted includes:
performing semantic analysis and/or content analysis on the (played) source video through a video port provided by the publisher, or performing semantic analysis and/or content analysis on a (pre-provided) low code rate source video, to determine one or more videos in the source video that satisfy a preset requirement.

Since the publisher has many source videos, which source video to be specially analyzed can be determined according to the visual object to be implanted and/or be accurately determined according to a video selection instruction.

The preset requirement may be a preset semantic requirement and a preset content requirement. The preset requirement is related to the visual object to a certain extent. For example, if the visual object is mineral water, the preset requirement may be the video scene where the actor who endorse the mineral water is located.

The semantic analysis may be artificial intelligence (AI) semantic analysis, etc., and the content analysis includes, but not limited to: scene analysis, character analysis and object analysis.

For example, when the publisher plays a source video with a low code rate, character analysis can be performed to obtain one or more videos containing Shen Teng in this video.

For another example:

When the publisher plays a source video with a low code rate, character analysis and scene analysis are performed to obtain one or more videos containing Shen Teng in KTV in this video; or, when the publisher plays a source video with a low code rate, character analysis, scene analysis and object analysis are performed to obtain one or more videos containing Shen Teng drinking water in KTV in this video.

For another example, scene analysis is performed on the source video through a video port provided by the publisher, to obtain one or more videos containing two actors A and B in a fight scene in this source video. Of course, in addition to semantic analysis and/or content analysis, artificial analysis or artificial selection can also be adopted. For example, it is possible to embed an advertisement within 1 minute of the opening of the source video.

The one or more videos are analyzed to determine one or more frames in which the visual object can be implanted.

During the analysis of the source video, one or more videos in the source video that satisfy a content requirement or semantic requirement can be obtained through a video port (e.g., sdk port) specially provided by the publisher of the source video or through the content analysis and/or semantic analysis of the source video with a low code rate, and the one or more videos are then analyzed to determine one or more specific frames in which the visual object can be implanted. In this way, during the video implantation, the flexibility of video analysis can be improved, and the processing terminal can freely select a proper video analysis mode according to the actual situation, thereby fully improving the video implantation efficiency.

In one embodiment, the analyzing the one or more videos to determine one or more frames in which the visual object can be implanted includes:
analyzing the one or more videos to determine a region of interest suitable for implantation of the visual object.

There are many ways to determine the region of interest. For example, according to the preset scene and the preset object, a region containing the preset scene and the preset object in the video frame is determined as the region of interest; or
according to the preset pixel value and/or the coordinates of the preset key point, a region satisfying the preset pixel value and/or the coordinates of the preset key point is determined as the region of interest.

The frame where the region of interest is located is determined as the one or more frames.

By analyzing the one or more videos again, the region of interest suitable for implantation of the visual object in these videos can be determined, and the frame where the region of interest is located is automatically determined as the one or more frames, thereby facilitating the implantation of the visual object into the region of interest and obtaining the output video implanted with the visual object.

In one embodiment, the acquiring a source video clip corresponding to the one or more frames includes:
acquiring the frame corresponding to the one or more frames in high code rate source video data.

The acquired frame corresponding to the one or more frames may be an uncompressed sequence frame with a high code rate, or may be a slightly compressed video.

The implanting the visual object into the source video clip corresponding to the one or more frames and generating one or more output videos includes:
implanting the visual object into the frame corresponding to the one or more frames in the high code rate source video data, and generating one or more output videos.

The high code rate source video data refers to the source video data with a code rate greater than a first preset code rate, the low code rate source video data refers to the source video data with a code rate less than a second preset code rate, and the first preset code rate is greater than or equal to the second preset code rate. For example, the high code rate source video data may be source video data with a code rate greater than or equal to 3073 kbps, and the low code rate source video data may be source video data with a code rate less than 1024 kbps.

Since the ultimate purpose is to generate a high-quality video, it is possible to acquire the frame corresponding to the one or more frames in the high code rate source video data and then automatically implant the visual object into the corresponding frame with a high code rate, so that one or more high-quality output videos containing the implantation object are generated on the processing terminal side.

The implanting the visual object into the source video clip corresponding to the one or more frames may include:
directly implanting the visual object into the region of interest in the source video clip corresponding to the one or more frames to generate one or more output videos;
or, the implanting the visual object into the source video clip corresponding to the one or more frames may further include:
implanting the visual object into a new frame, and then inserting the new frame into the source video clip corresponding to the one or more frames to finally generate one or more output videos;
or, the implanting the visual object into the source video clip corresponding to the one or more frames may further include:
directly implanting the visual object into the source video clip corresponding to the one or more frames, and then inserting a new frame into the source video clip to generate one or more output videos, wherein the new frame may be a frame containing the visual object, for example, a video frame of the mineral water to be advertised.

In addition, the output videos may be output in the form of videos or sequence frames.

In one embodiment, the acquiring the frame corresponding to the one or more frames in high code rate source video data further includes:
acquiring the frame corresponding to the one or more frames in the high code rate source video data according to a preset security frame strategy.

The preset security frame strategy is used to indicate the respective number of supplementary frames of the one or more frames. The number of supplementary frames of the one or more frames may be different. For example, the number of supplementary frames may be 1 or 2; and, the supplement direction may also be different, for example, supplementing to left, supplementing to right, or supplementing to both left and right.

The starting frame of the video may be different. For example, for a small video segment with 6 frames, the starting frame may be frame 0 or frame 1. If the frame 0 is the starting frame, the ending frame is frame 5; and, if the starting frame is frame 1, the ending frame is frame 6. In order to avoid the frame selection error caused by this situation, the preset security frame strategies are set for the one or more frames, respectively. Thus, the frame corresponding to the one or more frames in the high code rate source video data can be acquired automatically and accurately based on the preset security frame strategy, and the accuracy of selection of the frame suitable for implantation of the visual object can be improved.

For example, if the frames suitable for implantation of the visual object are frame 3 and frame 7 to frame 9 in the source video, and if the preset security frame strategy of the frame 3 is supplementing 1 frame to the left and the preset security frame strategies of the frame 7 to frame 9 are supplementing 1 frame to the left and to the right, the frames corresponding to the frame 3 in the high code rate source video data are frame 2 to frame 3, and the frames corresponding the frame 7 to frame 9 in the high code rate source video data are frame 6 to frame 10.

In one embodiment, the obtaining, by the publisher, the final video according to the video description information, the one or more output videos and the source video data of the source video clip includes at least one of the following steps.

The publisher replaces, according to the video description information, corresponding video segments in the source video data with the one or more output videos to obtain the final video. The corresponding video segments are video segments in the source video data that have the same starting time or starting frames as the output videos.

For example, if the video description information is only one output video and the starting frame and ending frame of this output video are the frame 3 and frame 10 in the source video data, respectively, the video segment from the frame 3 to frame 10 in the source video data can be replaced with this output video.

When the final vide is obtained, except that the corresponding video segment is replaced, the output video is still aligned with the video data in the remaining part of the source video data, and the content pictures of the video data in the remaining part of the final video remain unchanged.

The publisher embeds, according to the video description information, the one or more output videos into the corresponding position in the source video data to obtain the final video.

The corresponding position is determined according to the video description information. For example, if the video description information is only one output video and the starting frame and ending frame of this output video are the frame 8 and frame 14 in the source video data, respectively, the corresponding position may be the frame 8 in the source video data. Thus, the output video is interposed from the frame 8 of the source video data to obtain the final video.

The publisher overlays, according to the video description information, corresponding video segments in the source video data by using the one or more output videos to obtain the final video. When the final video is obtained, except for overlaying the corresponding video segment, the output video is still aligned with the video data in the remaining part of the source video data, and the content pictures in the video data in the remaining part of the final video remain unchanged.

The publisher can obtain the final video by replacement, embedding, overlaying or in other different ways, so that the flexibly of obtaining the video by the publisher is fully improved.

In one embodiment, the overlaying, by the publisher and according to the video description information, corresponding video segments in the source video data by using the one or more output videos to obtain the final video includes:
overlaying, by the publisher and according to the video description information, the one or more output videos on corresponding video segments in the source video data in a floating layer manner to obtain the final video;
or
overlaying, by the publisher and according to the video description information, the one or more rendered and masked output videos with alpha channel information on corresponding video segments in the source video data in a floating layer manner to obtain the final video;
or
implanting, by the publisher and according to the video description information, the one or more rendered and masked output videos with alpha channel information into corresponding video segments in the source video data in a rendering fusion manner according to the alpha channel information to obtain the final video. The floating layer manner differs from the rendering fusion manner in that: in the floating layer manner, there are still two pictures/two videos, that is, the one or more output videos are merely overlaid above the corresponding video segments in the source video data; while in the rendering fusion manner, two pictures/two videos are turned into one picture/one video, that is, the output video and the corresponding video segment are fused into one video segment.

The way of overlying the video segment by the publisher may be directly overlaying the whole output video above the corresponding video segment in the source video data in a floating layer manner, i.e., directly overlaying the whole video segment.

The way of overlaying the video segment by the publisher may also be overlaying the one or more rendered and masked output videos with alpha channel information above the corresponding video segment in a floating layer manner. That is, during overlaying, the transparency of the visual object implantation region in the output video is adjusted as 1, and the transparency of the region other than the visual object in the output video is adjusted as 0. It is equivalent that the output video containing the visual object is only overlaid above the picture in the region of interest in the source video data and the picture outside the region of interest in the source video data remains unchanged. In addition, the above-mentioned principle of “overlaying the visual object on the frame corresponding to the one or more frames in the source video data in a mask manner” is the same as the principle of overlaying the rendered and masked output video with alpha channel information in a floating layer manner in this embodiment, and will not be repeated.

The way of overlaying the video segment by the publisher may also be: implanting, by the publisher and according to the video description information, the one or more rendered and masked output videos with alpha channel information into corresponding video segments in the source video data in a rendering fusion manner according to the alpha channel information to obtain the final video.

The alpha channel information is a numerical value from 0 to 1 and is used to control the degree of fusion. A value of full 1 means that the pixels of the corresponding video segment are directly replaced, a value of less than 1 means fusion, and a value of 0 means that the pixels of the corresponding video segment are completely displayed. According to this numerical value, the one or more output videos will be rendered and superimposed with the source video for fusion, thereby achieving the rendering effect.

For convenience, the part of the masked output video with alpha is actually the masked transparent part (that is, the alpha information of the masked part is equal to 0), i.e., the part that needs to display the pixels of the underlying source video. Other pixel parts (that is, the region of interest is generally not masked) are parts that display the implantation object, and are not transparent. After fusion with the source video data, the purpose of replacing only the picture in the region of interest in the source video data with the picture of the visual object and remaining the pictures in other regions in the source video date unchanged can be achieved. In addition, the above-mentioned principle of “implanting the masked visual object into the frame corresponding to the one or more frames in a rendering fusion manner to obtain the final video” is the same as the video fusion principle in this embodiment, and will not be repeated.

Of course, a certain part of the region of interest may also have a mask, depending on the actual scenario, for example:

If it is finally determined that the roadside advertising board in the source video data is a region of interest for displaying the implantation object and when a vehicle (or person) passes by or blocks the advertising board, during masking, the processing terminal masks the part other than the region of interest, and also needs to mask the part with the vehicle (or person) in the region of interest, so that the picture of the source video data outside the region of interest and the picture in the part with the vehicle (or person) in the region of interest will be exposed. The publisher can flexibly select the three overlaying modes according to the requirements, so as to obtain the final video in a proper way.

It is to be noted that, for simplicity of description, the above method embodiments are all described as a series of act combinations; however, it should be understood by those skilled in that the present disclosure is not limited to the described act order, because some steps may be performed in other orders or simultaneously according to the present disclosure. Moreover, it should be understood by those skilled in the art that the embodiments described in this specification are all optional embodiments and the involved acts and modules are not necessary for the present disclosure.

The method embodiments have been described above, and the scheme of the present disclosure will be further described below by apparatus embodiments.

FIG. 2 shows a block diagram of a video implantation apparatus 200 according to an embodiment of the present disclosure. As shown in FIG. 2, the apparatus 200 includes:
a first processing module 210 configured to analyze a source video and recognize one or more frames in which a visual object can be implanted;
an acquisition module 220 configured to acquire a source video clip corresponding to the one or more frames; and
a second processing module 230 configured to implant the visual object into the source video clip corresponding to the one or more frames, and generate one or more output videos and video description information thereof; or
a generation module 240 configured to generate object description information according to the visual object and the source video clip corresponding to the one or more frames.

It should be clearly understood by those skilled in the art that, for convenience and conciseness of description, the specific operation processes of the described modules may refer to the corresponding processes in the above method embodiments and will not be repeated here.

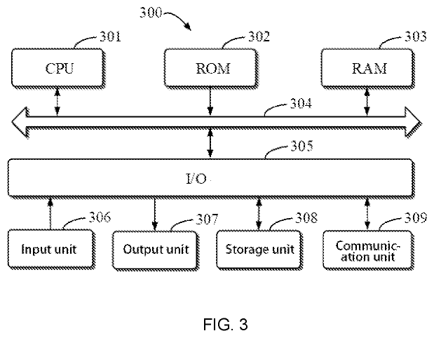

FIG. 3 shows a schematic block diagram of an electronic device 300 capable of implementing the embodiments of the present disclosure. The electronic device is intended to represent various forms of digital computers, such as laptop computers, desktop computers, work stations, personal digital assistants, servers, blade servers, large-scale computers, and other suitable computers. The electronic device may also represent various forms of mobile apparatuses, such as personal digital processing, cellular phones, smart phones, wearable devices and other similar computing apparatuses. The components shown herein, the connection and relationship among the components and the functions of the components are only examples, and are not intended to limit the implementations of the present disclosure described and/or claimed herein.

The apparatus 300 includes a computing unit 301 which can execute various appropriate acts and processing according to the computer programs stored in a read-only memory (ROM) 302 or computer programs loaded from a storage unit 303 to a random access memory (RAM) 303. The RAM 300 may also store various programs and data required for the operation of the apparatus 600. The computing unit 302, the ROM 302 and the RAM 303 are connected to each other via a bus 304. An input/output (I/O) interface 305 is also connected to the bus 304.

A plurality of components connected to the I/O interface 305 in the apparatus 300 include: an input unit 306, for example, a keyboard, a mouse, etc.; an output unit 307, for example, various types of displays, a loudspeaker, etc.; a storage unit 303, for example, a magnetic disk, an optical disk, etc.; and, a communication unit 309, for example, a network card, a modem, a wireless communication transceiver, etc. The communication unit 309 allows the apparatus 300 to exchange information/data with other devices through a computer network (e.g., the Internet) and/or various telecommunications networks.

The computing unit 301 may be various general-purpose and/or special-purpose processing components having the processing and computing capability. Some examples of the computing unit 301 include, but not limited to: a central processing unit (CPU), a graphics processing unit (GPU), various dedicated artificial intelligence (AI) computing chips, various computing units running machine learning model algorithms, digital signal processors (DSPs), and any suitable processor, controller, microcontroller, etc. The computing unit 301 executes the methods and processing described above, for example, the video implantation method. For example, in some embodiments, the video implantation method may be implemented as a computer software program that is tangibly included in a machine-readable medium, e.g., the storage unit 303. In some embodiments, some or all of the computer programs may be loaded and/or mounted onto the apparatus 300 via the ROM 302 and/or communication unit 309. When the computer program is loaded to the RAM 303 and executed by the computing unit 301, one or more steps of the video implantation method described above may be executed. Alternatively, in other embodiments, the computing unit 301 may be configured to execute the video implantation method in any other suitable ways (e.g., by means of firmware).

Various implementations of the system and technology described above herein may be implemented in digital electronic circuitries, integrated circuitries, field programmable gate arrays (FPGAs), application specific integrated circuits (ASICs), application specific standard products (ASSPs), systems on chip (SOCs), complex programmable logic devices (CPLDs), computer hardware, firmware, software, and/or combinations thereof. These various implementations may include implementations in one or more computer programs. The one or more computer programs may be executed and/or interpreted on a programmable system including at least one programmable processor. The programmable processor may be a special-purpose or general-purpose programmable processor, and can receive data and instructions from a storage system, at least one input device and at least one output device and transmit data and instructions to the storage system, the at least one input device and the at least one output device.

The program codes for implementing the method of the present disclosure may be written in any combination of one or more programming languages. These program codes may be provided to the processors or controllers of general-purpose computers, special-purpose computers or other programmable processing apparatuses, so that the functions/operations specified in the flowcharts and/or block diagrams are implemented when the program codes are executed by the processors or controllers. The program codes may be executed entirely on a machine, executed partially on a machine, executed partially on a machine and partially on a remote machine as separate software packages, or executed entirely on a remote machine or server.

In the context of the present disclosure, the machine-readable medium may be a tangible medium, which may contain or store programs for use by or use with an instruction execution system, apparatus or device. The machine-readable medium may be a machine-readable signal medium or a machine-readable storage medium. The machine-readable medium may include, but not limited to: electronic, magnetic, optical, electromagnetic, infrared or semiconductor systems, apparatuses or device, or any suitable combination thereof. More specific examples of the machine-readable storage medium include: electrical connections based on one or more leads, portable computer disks, hard disks, random access memories (RAMs), read-only memories (ROMs), erasable programmable read-only memories (EPROMs or flash memories), optical fibers, portable compact disc read-only memories (CD-ROMs), optical storage devices, magnetic storage devices, or any suitable combination thereof.

In order to provide interaction with a user, the system and technology described herein may be implemented on a computer having: a display device (e.g., a cathode ray tube (CRT) or liquid crystal display (LCD) monitor) configured to display information to the user; and a keyboard and a pointing device (e.g., a mousse or a trackball), through which the user can provide an input to the computer. It is also possible to use other types of apparatuses to provide interaction with the user. For example, the feedback provided to the user may be any form of sensory feedback (e.g., visual feedback, auditory feedback or tactile feedback), and the input from the user may be received in any form (including acoustic input, voice input or tactile input).

The system and technology described herein may be implemented in a computing system (e.g., as a data server) including back-end components, or a computing system (e.g., an application server) including middleware components, or a computing system (e.g., a user computer having a graphical user interface or web browser, through which the user can interact with the implementations of the system and technology described herein) including front-end components, or a computing system including any combination of back-end components, middleware components or front-end components. The components of the system may be connected to each other by any form or medium of digital data communication (e.g., a communication network). Examples of the communication device include: a local area network (LAN), a wide area networks (WAN) and the Internet.

The computing system may include a client and a server. The client and the server are generally far away from each other, and generally interact with each other through a communication network. The relationship between the client and the server is generated by computer programs that are run on the corresponding computer and have a client-server relationship. The server may be a cloud server, a server of a distributed system, or a server combined with a block chain.

It should be understood that the steps may be re-ordered, added or deleted by using various forms of processes shown above. For example, the steps recorded in the present disclosure may be executed concurrently, sequentially or in a different order as long as the desired results of the technical solutions disclosed in the present disclosure can be achieved, and it will not be limited therein.

The above specific implementations do not limit the protection scope of the present disclosure. It should be understood by those skilled in the art that various modifications, combinations, sub-combinations and substitutions can be made according to the design requirements and other factors. Any modifications, equivalent substitutions and improvements made without departing from the spirit and principle of the present disclosure shall fall into the protection scope of the present disclosure.

1. A video implantation method, comprising steps of:
analyzing a source video and recognizing one or more frames in which a visual object can be implanted;
acquiring a source video clip corresponding to the one or more frames; and
implanting the visual object into the source video clip corresponding to the one or more frames, and generating one or more output videos and video description information thereof;
or
generating object description information according to the visual object and the source video clip corresponding to the one or more frames, the object description information being used to describe the implantation position of the visual object in the one or more frames and the specific information of the one or more frames, the one or more frames being obtained by the following steps: analyzing the source video and recognizing one or more frames in which the visual object can be implanted;
the analyzing the source video comprises:
performing semantic analysis and/or content analysis on the source video through a video port provided by a publisher, it being unnecessary to obtain the complete source video when the source video being analyzed;
after the semantic analysis and/or content analysis is performed on the source video, determining one or more videos in the source video that satisfy a preset requirement, the preset requirement being associated with the visual object; and
analyzing the one or more videos to determine one or more frames in which the visual object can be implanted.

2. The method according to claim 1, further comprising:
sending the one or more output videos and the video description information thereof to the publisher, so that the publisher obtains the final video according to the video description information, the one or more output videos and the source video data of the source video clip; or
sending the visual object and the object description information to the publisher, so that the publisher overlays the visual object on the frame corresponding to the one or more frames in the source video data in a mask manner according to the object description information; or
sending the masked visual object and the object description information to the publisher, so that the publisher implants the masked visual object into the frame corresponding to one or more frames in a rendering fusion manner according to the object description information to obtain the final video.

3. The method according to claim 1, wherein,
the generating object description information according to the visual object and the source video clip corresponding to the one or more frames comprises:
analyzing a region of interest suitable for implantation of the visual object in the source video clip corresponding to the one or more frames to determine the object description information; and
storing multiple versions of source videos by the publisher, each version of source video being different in code rate and/or language version; and
the analyzing a source video and recognizing one or more frames in which a visual object can be implanted comprises:
analyzing any version of source video among the multiple versions of source videos and recognizing one or more frames in which the visual object can be implanted.

4. The method according to claim 1, further comprising:
generating the video description information according to the respective time interval and/or frame interval of the one or more output videos, the video description information being used to describe the respective starting time and ending time of the one or more output videos in the source video data, and/or the video description information being used to describe the respective starting frame number and ending frame number of the one or more output videos in the source video data.

5. The method according to claim 1, wherein,
the analyzing the one or more videos to determine one or more frames in which the visual object can be implanted comprises:
analyzing the one or more videos to determine a region of interest suitable for implantation of the visual object; and
determining the frame where the region of interest is located as the one or more frames.

6. The method according to claim 1, wherein,
the acquiring a source video clip corresponding to the one or more frames comprises:
acquiring the frame corresponding to the one or more frames in high code rate source video data; and
the implanting the visual object into the source video clip corresponding to the one or more frames and generating one or more output videos comprises:
implanting the visual object into the frame corresponding to the one or more frames in the high code rate source video data, and generating one or more output videos.

7. The method according to claim 6, wherein,
the acquiring the frame corresponding to the one or more frames in high code rate source video data further comprises:
acquiring the frame corresponding to the one or more frames in the high code rate source video data according to a preset security frame strategy;
wherein the preset security frame strategy is used to indicate the respective number of supplementary frames of the one or more frames.

8. The method according to claim 2, wherein,
the obtaining, by the publisher, the final video according to the video description information, the one or more output videos and the source video data of the source video clip comprises at least one of the following steps:
replacing, by the publisher and according to the video description information, corresponding video segments in the source video data with the one or more output videos to obtain the final video;
embedding, by the publisher and according to the video description information, the one or more output videos into the corresponding position in the source video data to obtain the final video; and
overlaying, by the publisher and according to the video description information, corresponding video segments in the source video data by using the one or more output videos to obtain the final video.

9. The method according to claim 8, wherein,
the overlaying, by the publisher and according to the video description information, corresponding video segments in the source video data by using the one or more output videos to obtain the final video comprises:
overlaying, by the publisher and according to the video description information, the one or more output videos on corresponding video segments in the source video data in a floating layer manner to obtain the final video;
or
overlaying, by the publisher and according to the video description information, the one or more rendered and masked output videos with alpha channel information on corresponding video segments in the source video data in a floating layer manner to obtain the final video;
or
implanting, by the publisher and according to the video description information, the one or more rendered and masked output videos with alpha channel information into corresponding video segments in the source video data in a rendering fusion manner according to the alpha channel information to obtain the final video.

10. A video implantation apparatus, comprising:
a first processing module configured to analyze a source video and recognize one or more frames in which a visual object can be implanted;
an acquisition module configured to acquire a source video clip corresponding to the one or more frames; and
a second processing module configured to implant the visual object into the source video clip corresponding to the one or more frames, and generate one or more output videos and video description information thereof;
or
a generation module configured to generate object description information according to the visual object and the source video clip corresponding to the one or more frames, the object description information being used to describe the implantation position of the visual object in the one or more frames and the specific information of the one or more frames, the one or more frames being obtained by the following steps: analyzing the source video and recognizing one or more frames in which the visual object can be implanted;
the analyzing the source video comprises:
performing semantic analysis and/or content analysis on the source video through a video port provided by a publisher, where the complete source video does not need to be acquired during the analysis of the source video;
after the semantic analysis and/or content analysis is performed on the source video, determining one or more videos in the source video that satisfy a preset requirement, the preset requirement being associated with the visual object; and
analyzing the one or more videos to determine one or more frames in which the visual object can be implanted.

11. An electronic device, comprising:
at least one processor; and
a memory communicatively connected to the at least one processor, wherein,
the memory has instructions stored thereon that can be executed by the at least one processor, and the instructions enable, when executed by the at least processor, the at least one processor to execute the method according to claim 1.

12. A non-transient computer-readable storage medium having computer instructions stored thereon that are configured to cause a computer to execute the method according to claim 1.
